(19) United States
(12) Patent Application Publication
(10) Pub. No.: US 2006/0202796 A1
(43) Pub. Date: Sep. 14, 2006

(54) Closing system

(75) Inventor: Frank Sommer, Kirchheim/Teck (DE)

Correspondence Address: VENABLE LLP, P.O. BOX 34385, WASHINGTON, DC, 20045-9998, US

(73) Assignee: Sommer Antriebs- und Funktechnik GmbH, Kirchheim/Teck (DE)

(21) Appl. No.: 11/359,771

(22) Filed: Feb. 23, 2006

(30) Foreign Application Priority Data
Feb. 23, 2005 (DE) 20 2005 002 888.6

(51) Int. Cl. H04L 9/32

(52) U.S. Cl. 340/5.22; 340/825.69; 340/5.71; 340/5.23; 340/5.25; 340/5.64

(57) ABSTRACT

A closing system for a non-contacting operation of a door or a gate comprises a transmitter/receiver system including a plurality of transmitters and a receiver. Each transmitter respectively includes a computer unit and an input device. Each input device is operative to program a transmitting code into the respective computer unit. The receiver includes a storage unit with at least one storage location for storing the transmitting codes transmitted by the transmitters during a teach-in process.

### CROSS-REFERENCE TO RELATED APPLICATION

This application claims the priority of German Application DE 20 2005 002 888.6 filed on Feb. 23, 2005, the subject matter of which is incorporated herein by reference.

### BACKGROUND OF THE INVENTION

The invention relates to a closing system that includes a transmitter/receiver system for a non-contacting operation of a door or a gate, wherein a code is transmitted from a transmitter to a receiver for operating the door or gate.

A closing system of this type is known from German patent document DE 36 25 555 C2. This closing system comprises a transmitter/receiver system for the remote operation of a garage door and comprises at least one transmitter and one receiver. The receiver is provided with a programming switch, a memory for storing transmitting codes, and a microprocessor for comparing a signal received by the receiver to the content of the memory. In case of a match, the receiver effects the garage-door operation. The system is provided with several transmitters, wherein each transmitter has an individual code specifically assigned to it. The number of storage locations in the memory corresponds at least to the number of transmitters. The receiver is provided with a storage location selection switch, wherein the respective storage location is selected during the programming of the system by using the storage-location selection switch and is then occupied by the code for the respective transmitter. During operation of the system, a signal picked up by the receiver is compared by the microcomputer to the content of one of the storage locations in the memory, to determine if there is a match.

The above-referenced system allows the operation of several garage doors with the aid of a single transmitter, as well as the operation of a single garage door by several transmitters.

This system has the disadvantage that when a transmitter is added to the transmitter/receiver system, the transmitting code for the added transmitter must also be stored in the receiver, wherein the storage location selection switch must be activated each time. As a result, the handling of the system is made more complicated for the user, particularly with a system comprising a large number of transmitters.

A further disadvantage is that the replacement of a transmitter, in the event of loss or malfunction, is extremely involved because of the transmitting code already programmed into the receiver. Owing to the fact that the transmitting codes in the transmitters are not known to the user, localizing a transmitting code in the memory of the receiver is accordingly very difficult or even impossible and may require deleting all transmitting codes in the receiver before the desired set of transmitting codes can be input.

### SUMMARY OF THE INVENTION

It is an object of the present invention to provide a closing system of the aforementioned type, which is highly user-friendly and simultaneously provides maximum protection against manipulation.

The above and other objects are accomplished according to the invention wherein there is provided, in an exemplary embodiment, a closing system for a non-contacting operation of a door or a gate, comprising: a transmitter/receiver system including a plurality of transmitters and a receiver, each transmitter respectively including a computer unit and an input device, wherein each input device is operative to program a transmitting code into the respective computer unit, and the receiver includes a storage unit with at least one storage location for storing the transmitting codes transmitted by the transmitters during a teach-in process.

In accordance with the invention, therefore, a user of the closing system may specify the transmitting code or codes and may program these into the transmitters, wherein the receiver may then acquire the transmitting codes during a teach-in process.

By contrast to presetting the transmitting codes with a dual inline package (DIP) switch, the programmed-in transmitting codes according to the invention are available only to the user and cannot be read out on the transmitter. The closing system according to the invention thus has a high protection against manipulation.

One essential advantage of the closing system according to the invention is that the transmitting codes can be programmed into the transmitters without an external programming device, thus keeping the structural expenditure for the closing system at a minimum. For the programming in and storing of the transmitting codes, it is only necessary for the individual transmitters to contain a computer unit, for example, in the form of a microprocessor, wherein this results in only a slight increase in the production costs for the transmitters. It is particularly advantageous that the keys already existing on the transmitter can be used as the input device for programming in the transmitting codes. A transmitting code can be input using a combination of several keys, in the simplest case two keys.

The user then notes down the entered key combination, so that the transmitting code defined in this way can also be programmed into additional transmitters for the closing system.

In the simplest case, the receiver of the closing system according to the invention comprises a storage unit with only one storage location, in which consequently only one transmitting code can be stored. In that case, the same transmitting code is programmed into all transmitters of the closing system. A sufficiently high protection against manipulation is ensured because only the user knows this code. As a result, a malfunctioning transmitter can be replaced at low cost with a new one, into which the known transmitting code is programmed, because the user already knows the transmitting code. The closing system is thus extremely user friendly.

According to one advantageous modification of the invention, the storage unit in the receiver can also comprise a plurality of storage locations in which a corresponding plurality of transmitting codes can be stored. In that case, the user can program different transmitting codes, selected by the user, into the transmitters. In this case it is also possible to program the same transmitting code into some or all of the transmitters.

In each case, the receiver acquires a transmitting code programmed into a transmitter during a teach-in process. For this, the receiver is first readied for the teach-in and the code is then transmitted from the transmitter to the receiver where it is stored in the storage unit.

A separate teach-in process is not required for each transmitter because respectively several transmitters, in the simplest case all transmitters, of the closing system are programmed with the same transmitting code. The teach-in process is required only for the number of transmitters that correspond to the number of different transmitting codes, in the simplest case only for one transmitter. The teach-in process can thus be carried out with extremely low expenditure for the user.

It is particularly advantageous if the closing system is delivered with a transmitting code already programmed into the transmitters, which is not known to the user. Following the teach-in and storage of the transmitting code in the receiver, the user can start the operation of the closing system. If the user desires to program in one or several transmitting codes, selected by the user, simply deleting the original transmitting codes can do this. The user can thus specify once, or multiple times, the transmitting codes, selected by the user.

### BRIEF DESCRIPTION OF THE DRAWINGS

These and other features and advantages of the invention will be further understood from the following detailed description of the preferred embodiments with reference to the accompanying drawings, which show in:

FIG. 1: A schematic representation of a closing system for the non-contacting operation of a door according to the invention.

FIG. 2: A schematic representation of a transmitter for the closing system shown in FIG. 1.

FIG. 3: A schematic representation of the receiver for the closing system shown in FIG. 1.

FIG. 4: An example of a transmitting code, programmed into a transmitter according to FIG. 2.

### DETAILED DESCRIPTION OF THE INVENTION

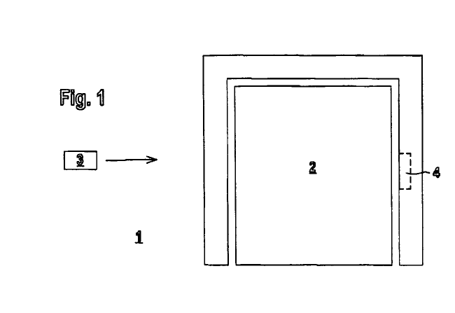

FIG. 1 is a schematic representation of a closing system 1 for the non-contacting operation of a garage door 2. In place of a garage door 2, the system can generally also be used to operate any door or gate.

The closing system 1 comprises a transmitter/receiver system with several transmitters 3, wherein FIG. 1 shows only one of these transmitters 3, along with a receiver 4 that is assigned to the transmitters 3. The receiver 4 is arranged inside the garage and is accessible to an operator.

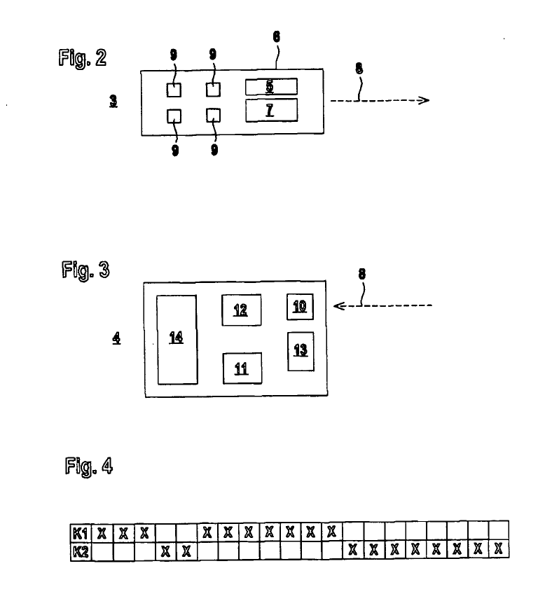

The transmitters 3 are designed identical to the one shown in FIG. 2. FIG. 3 shows a schematic configuration of the receiver 4.

The transmitter 3 shown in FIG. 2 is designed as hand-held transmitter and is provided with a computer unit 5, which is integrated into a housing 6. The computer unit 5 has an integrated memory and may be, for example, a microcontroller. The transmitter 3 comprises a radio-transmitting module 7 for transmitting coded radio signals 8. The transmitter 3 can be operated with the aid of keys 9, wherein depressing specific key combinations can emit predetermined radio signals 8. The keys 9, in particular, also form an input device for entering data into the computer unit.

The receiver 4, shown in FIG. 3, comprises a radio-receiver module 10 for receiving the radio signals 8 from the transmitter 3. The receiver 4 furthermore comprises a computer 11 for decoding the radio signals 8 from the transmitter 3. The computer 11 can be a microcontroller in the same way as the computer unit 5 in transmitter 3. The receiver 4 furthermore comprises a storage unit 12 with a predetermined number of storage locations.

The storage unit 12 in the present case is embodied as a separate unit. Alternatively, the storage unit 12 can also be integrated into the computer 11.

The computer 11 for the receiver 4 actuates a light-emitting diode 13, which indicates the status, wherein other signal indicators, in particular acoustic signal transmitters, can also be used in place of a light-emitting diode 13.

Finally, the receiver 4 comprises an actuation element 14 that is connected to the computer 11 and, for the present embodiment, comprises a single key. However, the actuation element can also comprise several keys.

With the exemplary embodiment, the storage unit 12 in the receiver 4 has only one location for storing a transmitting code. To activate the garage door 2, a transmitter 3 transmits a stored transmitting code to the receiver 4, where it is received by the radio-receiving module 10 and is decoded in the computer 11. If the code transmitted by the transmitter 3 coincides with the transmitting code stored in the storage unit 12, then the garage door 2 is activated, meaning it is opened or closed.

With a closing system 1 comprising several transmitters 3, assigned to one receiver 4, the transmitting code stored in the individual transmitter 3 is respectively also stored in the receiver 4, so that these transmitters can trigger the activation of the garage door 2 by transmitting the code to the receiver 4.

If the closing system 1 is delivered, complete with a transmitter 3 and a receiver 4, the transmitting code programmed into the transmitter 3 is not known to the user. If the user would like to operate the closing system 1 with this transmitter 3 and the code programmed into it, the user can prepare the receiver 4 for the input by actuating the actuation element, in the present case by briefly depressing the key 14 which forms the actuation element. The readiness for the teach-in process is indicated through blinking of the light-emitting diode 13 on the receiver 4. During the subsequent teach-in process, the transmitting code is transmitted by the transmitter 3 to the receiver 4 and is stored in a free storage location therein. At the completion of the teach-in process, the user can operate the closing system 1 with this transmitter 3 and can activate the garage door 2.

If the user wishes to have several transmitters 3 for operating the garage door 2, the user can program a new transmitting code, selected by the user, into the transmitters 3. For the input of the new transmitting code into the receiver 4, the old transmitting code must first be deleted in the storage unit 12 of the receiver 4, wherein the actuation element is actuated accordingly. In the present case, the transmitting code is deleted by depressing the key 14, which forms the actuating element, for an extended period of time.

A non-contacting control of the receiver operation can in general also be used in place of a key 14 for the actuation element. In that case, a transmitter 3 sends out specific identification codes to prepare the receiver 4 for the teach-in process, or the memory content of the receiver storage unit 12 is deleted.

To program a transmitting code into the transmitter 3, the transmitter is first prepared for the teach-in process. A predetermined number of keys 9 on the transmitter 3 are provided for this. In the simplest case, a specific key 9 functions to ready the transmitter 3.

Following this, the transmitting code selected by the user is input into the computer unit 5 for the transmitter 3 via the keys 9, which form the input device, and is stored in the memory. A specific key combination of at least two different keys 9 is used for the input of the transmitting code. The serial depressing of keys 9 specifies the pattern for the transmitting code.

In the present case, the transmitting code consists of a 20-position key combination, wherein FIG. 4 shows one example for a transmitting code of this type. For the input of this transmitting code, a key K1 is initially depressed three times and a key K2 is then depressed two times. Following this, the key K1 is depressed seven times and finally, the key K2 is depressed eight times.

The user makes a note of the entered transmitting code, so that this code can be programmed in the same way into the remaining transmitters 3 for the closing system 1.

The receiver 4 is prepared for the process of teaching the transmitting code into the receiver, wherein the new transmitting code is transmitted by one of the transmitters 3 to the receiver 4 during an additional teach-in process.

All transmitters 3 of the closing system 1 can thus operate the garage door 2 because the same transmitting code is stored in all transmitters 3. The closing system 1 is protected against manipulation because the transmitting code cannot be read out at the transmitter 3 and is known only to the authorized user who programmed it in.

According to a different embodiment of the closing system 1, the receiver 4 can be provided with a storage unit 12 having a plurality of storage locations, wherein respectively one transmitting code is stored in each storage location.

In that case, one transmitting code can respectively be programmed into a predetermined number of transmitters 3. One of the transmitters 3, of the group of transmitters with a different code, is then used for the input of this transmitting code into the receiver 4 by means of a teach-in process.

The invention has been described in detail with respect to preferred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

What is claimed is:

1. A closing system for a non-contacting operation of a door or a gate, comprising:
a transmitter/receiver system including a plurality of transmitters and a receiver, each transmitter respectively including a computer unit and an input device, wherein each input device is operative to program a transmitting code into the respective computer unit, and the receiver includes a storage unit with at least one storage location for storing the transmitting codes transmitted by the transmitters during a teach-in process.

2. The closing system as defined in claim 1, wherein each input device includes a predetermined number of keys on the respective transmitter.

3. The closing system as defined in claim 2, wherein a predetermined number of keys of each input device are intended for the input of the transmitting code.

4. The closing system as defined in claim 2, wherein each input device includes a predetermined number of keys to put the respective transmitter into the teach-in mode.

5. The closing system as defined in claim 1, wherein each computer unit comprises a microcontroller integrated into the respective transmitter.

6. The closing system as defined in claim 1, wherein the storage unit in the receiver comprises a single storage location for storing a transmitting code.

7. The closing system as defined in claim 1, wherein the storage unit in the receiver comprises a plurality of storage locations for storing a predetermined number of transmitting codes.

8. The closing system as defined in claim 1, wherein the receiver comprises an actuation element to change the receiver to a teach-in mode.

9. The closing system as defined in claim 1, wherein the transmitting codes transmitted by the transmitters are encoded radio signals, which are subsequently decoded in the receiver.
